(19) United States
(12) Patent Application Publication
(10) Pub. No.: US 2006/0206435 A1
(43) Pub. Date: Sep. 14, 2006

(54) Shopper identification via tender

(75) Inventors: Robert S. Hoblit, Knightdale, NC (US); David Lee Johnson, Clayton, NC (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corporation, Armonk, NY (US)

(21) Appl. No.: 11/079,360

(22) Filed: Mar. 14, 2005

(51) Int. Cl. G06Q 99/00

(52) U.S. Cl. 705/65

(57) ABSTRACT

A method and system for purchasing products through a government assistance program such as WIC is presented. After all WIC and non-WIC qualified items are scanned at a store's check-out station, a WIC eligible participant tenders a WIC smart card. The WIC smart card identifies the eligible user, and also selectively tenders a governmental payment credit for only the WIC qualified items.

### BACKGROUND OF THE INVENTION

1. Technical Field

The present invention relates in general to the field of computers, and in particular to Point-Of-Sale (POS) tender devices. Still more particularly, the present invention relates to a method and system for identifying at a time of tender any products that are eligible for payment by a government assistance program.

2. Description of the Related Art

Poverty and hunger are a bane to all persons. However, inadequate nutrition is especially harsh on pregnant or postpartum women, infants, and children under the age of five. To address this problem, the United States government, and particularly the United States Department of Agriculture (USDA), in conjunction with local state governments, has initiated a program known as WIC, which stands for Women, Infants and Children.

Women and children meeting income eligibility and age guidelines, which are set by the individual states, receive monthly WIC vouchers that are used to purchased approved food products, such as iron-fortified infant formula and infant cereal, vitamin C-rich fruit and/or vegetable juice, eggs, milk, cheese, peanut butter, dried beans or peas, tuna fish, carrots, etc. Items not eligible for purchase with the WIC vouchers include obvious items such as alcohol and tobacco products, as well as not-so-obvious items such as packaged cereals with low nutritional value, candy, etc. Furthermore, product eligibility often depends on quantity as well. For example, a mother with two small children may be eligible for no more than two gallons of milk per week. In addition, most WIC programs require a food vendor to sell a lease expensive brand of a product in order for that product to be eligible for payment with a WIC voucher.

When a WIC benefits recipient shops for food in a grocery store, she selects items from shelves in a normal manner. At a check-out station, either the WIC benefits recipient or a store employee (checker) must then sort out which items are WIC eligible, so that the shopper can pay for them separately using her WIC vouchers. Non-WIC eligible items are then paid for with cash, check or credit card from the shopper.

This system of payment has multiple problems. First, as described above, the rules regarding which products are WIC eligible are complex and often changing, making it very difficult for even an experienced checker at the check-out station to identify which items are and are not WIC eligible. Second, this system requires the WIC recipient to first identify herself as such before the WIC eligible product is scanned by the checker, in order to segregate out the WIC and non-WIC eligible products for payment. Third, the vouchers themselves may have a negative connotation, as they are viewed by many as a red flag that the user is a “charity case.” As it is an express desire of the WIC programs to help those in need without any stigma attached, the third problem is viewed by many as the most critical.

### SUMMARY OF THE INVENTION

In response to the shortcomings of the prior art system described, the present invention is thus directed to a method and system for purchasing products through a government assistance program such as WIC. After all WIC and non-WIC qualified items are scanned at a store's check-out station, a WIC eligible participant tenders a WIC smart card. The WIC smart card identifies the eligible user, and also selectively tenders a governmental payment credit for only the WIC qualified items.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts an exemplary computer system which may be utilized by a check-out station in the present invention;

FIG. 2 illustrates an exemplary remote server that supports the computer system shown in FIG. 1;

FIG. 3 is an exemplary smart card as used by the present invention;

FIG. 4 is a flow-chart of exemplary steps taken in the present invention; and

FIG. 5 is an exemplary display showing options available to an eligible participant in a government assistance program as contemplated by the present invention.

### DETAILED DESCRIPTION OF THE PREFERRED EMBODIMENT

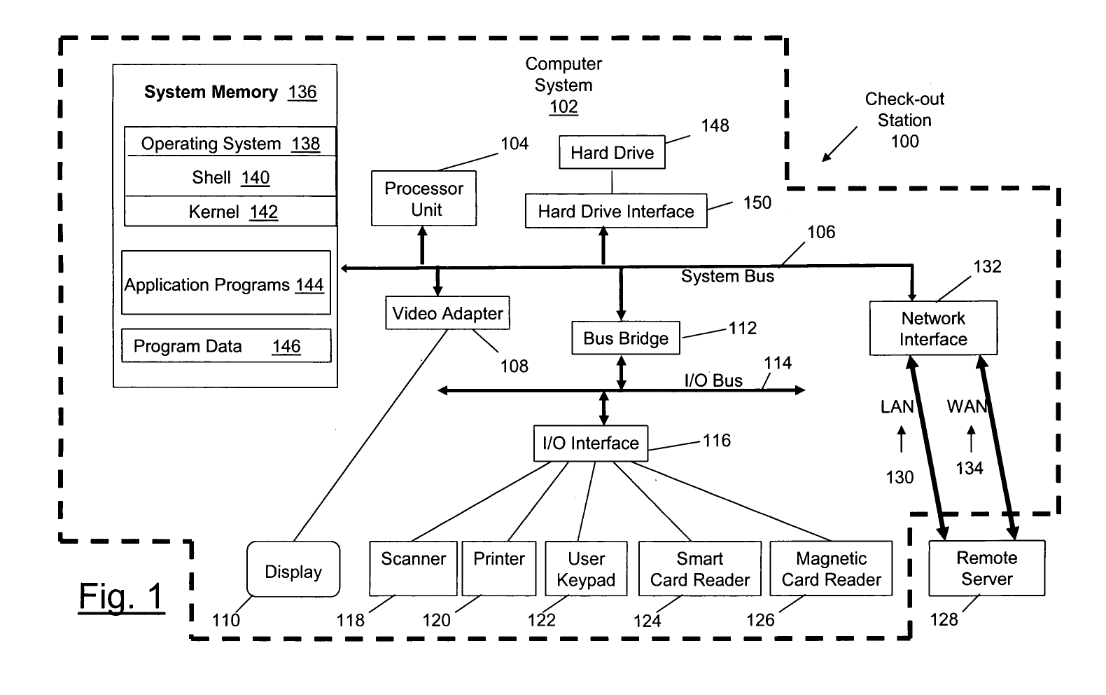

With reference now to the figures, and particularly to FIG. 1, there is depicted a block diagram of an exemplary data processing system that may be used at a check-out station 100. Note that check-out station 100 is understood to include a physical structure and mechanical devices common to a check-out station in a grocery or similar store. That is, not shown but understood to be present are one or more conveyor belts for transporting selected grocery items from a shopper's cart to a scanner and then on to a bagging area, a check-writing stand, etc., all of which are associated with a typical check-out station.

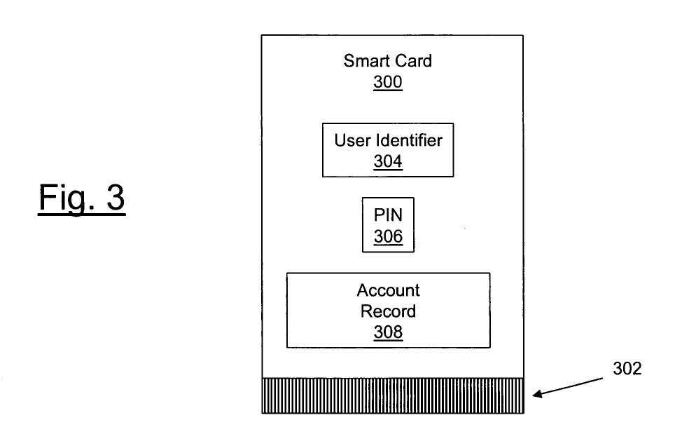

Key to check-out station 100 is a computer system 102, which includes a processor unit 104 coupled to a system bus 106. Also coupled to system bus 106 is a video adapter 108, which drives/supports a display 110. System bus 106 is coupled via a bus bridge 112 to an Input/Output (I/O) bus 114. Coupled to I/O bus 114 is an I/O interface 116, which affords communication with various I/O devices, including a scanner 118, a printer 120, a user keypad 122, a smart card reader 124, and a magnetic card reader 126. Additional detail regarding a smart card that is read by smart card reader 124 is provided below in FIG. 3.

Computer system 102 is able to communicate with a remote server 128 via a Local Area Network (LAN) 130, which is coupled to system bus 106 via a network interface 132. Alternatively, network interface 132 may include a modem or like device (not shown), thus permitting computer system 102 to communicate with remote server 128 via a Wide Area Network (WAN) 134, such as the Internet, preferably using Internet Protocol (IP) data packets. Note that LAN 130 and/or WAN 134 may use wired or wireless networks.

Preferably, computer system 102 has minimal local storage resources. Therefore, a system memory 136 is preferably populated remotely by remote server 128. Alternatively, system memory 136 may be populated by a local secondary storage system, which uses a local computer-readable media such as an on-board hard disk in a hard drive 148, which is coupled to system but 106 via a hard drive interface 150.

Data that populates system memory 134 includes computer system 102's operating system 138, which includes a command interpreter program known as a shell 140, which is incorporated in a higher level operating system layer and utilized for providing transparent user access to resources such as application programs 144 and program data 146.

As is well known in the art, a command interpreter or “shell” is generally a program that provides an interpreter and interfaces between the user and the operating system. More specifically, a shell program executes commands that are entered into a command line user interface or from a file.

The shell (Unix) or command processor (Windows) is generally the highest level of the operating system software hierarchy and serves as a command interpreter. The shell typically provides a system prompt, interprets commands entered by keyboard, mouse, or other user input media, and sends the interpreted command(s) to the appropriate lower levels of the operating system (e.g. a kernel 142) for processing.

An exemplary application program 144 used in the present invention is a program designed to correlate which WIC products are eligible to be purchased by a government assistance program for the benefit of a specific user. Exemplary program data 146 correlates eligible WIC products to specific users, preferably through the use of flags or similar data identifiers.

The hardware elements depicted in computer system 102 are not intended to exhaustive, but rather are representative to highlight essential components required by the present invention. Thus, computer system 102 may include a cashier's keyboard for manually entering product codes, prices, transaction (including purchase/scan voiding) instructions, as well as other I/O devices such as pointers, a mouse, etc. Furthermore, while computer system 102 is shown as having only a hard drive 148 for local secondary storage on a computer-readable media (hard disk), alternatively computer system 102 may use any type of media for data storage known to those skilled in the art, including but not limited to removable magnetic disks, Compact Disk Read Only Memories (CD-ROMs) magnetic cassettes, flash memory cards, digital versatile disks (DVDs), Bernoulli cartridges, and the like.

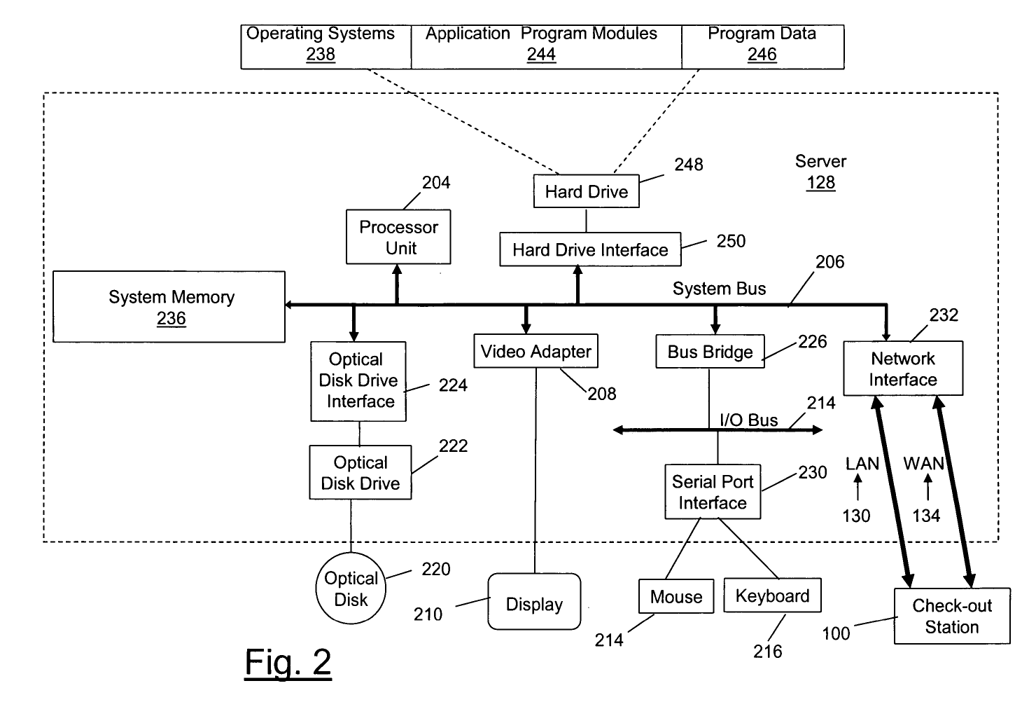

With reference now to FIG. 2, an exemplary server 128 is depicted. Server 128 includes a processor unit 204, which controls overall functions of server 128, including the control of data that is communicated to and from check-out station 100 via a network interface 232 and LAN 130 and/or WAN 134. Server 128 includes a system bus 206, to which is coupled a video adapter 208 that drives a display 210, allowing an operator to monitor and control operations of server 128. To facilitate this operation and user interaction, a bus bridge 226 is coupled to an Input/Output (I/O) bus 214, which couples to a serial port interface 230, such as but not limited to a Universal Serial Bus (USB) interface port, which provides I/O communication from a mouse 214, keyboard 216, or other input device.

Also coupled to system bus 206 is a hard drive interface 250 and an optical disk drive interface 224, which are respectively used to read from or write to a magnetic hard disk in a hard drive 248 and an optical disk 220 in an optical disk drive 222 drive 246. The drives and their associated computer-readable media provide non-volatile data storage for both server 128 and computer system 102. While the above description of computer-readable media refers to an on-board hard disk, a removable magnetic disk, and a CD-ROM disk, it is understood by those skilled in the art that other types of media which are readable by a functionally equivalent computer, such as magnetic cassettes, flash memory cards, digital video disks, Bernoulli cartridges, and the like, may also be used in the exemplary computer operating environment.

Also coupled to system bus 206 is a system memory 236, which includes data and programs necessary for the operation of server 128, and may also include a data hierarchy for caching data to be sent to and from check-out station 100.

Server 128 has direct access to and control of software that includes operating systems 238, applications program modules 244, and program data 246, all of which are preferably stored in hard drive 248. Operating systems 238 include any operating system, such as a Unix® operating system or Windows® XP, which is available from Microsoft Corporation, that may be used by a computer system 102 in a check-out station 100, including operating system 138 shown in FIG. 1. Likewise, application program modules 244 include any application programs that may be used by computer system 102, including application programs 144 described above, and program data 246 may include program data 146 as described in FIG. 1. Note also that application program 144 may include a web browser that includes program modules and instructions enabling a world wide web client (i.e., computer system 102 and server 128 each having a web address) to send and receive network messages over WAN 134, representing the Internet, using HyperText Transfer Protocol (HTTP) messaging.

Note again that the exemplary embodiments shown in FIGS. 1 and 2 are provided solely for the purposes of explaining the invention, and those skilled in the art will recognize that numerous variations are possible, both in form and function. For instance, computer system 102 and/or server 128 might also include a compact disk read-only memory (CD-ROM) or digital versatile disk (DVD) drive, a sound card and audio speakers, and numerous other optional components. All such variations are believed to be within the spirit and scope of the present invention.

Referring now to FIG. 3, an exemplary smart card 300 as used by the present invention is presented. Smart card 300 interfaces with a smart card reader (such as smart card reader 124 shown in FIG. 1) via a pin interface 302, which provides data communication with computer system 102 via smart card reader 124. Stored within smart card 300 is a user identifier 304, which identifies the user/holder of the smart card 300 as being an authorized WIC participant (beneficiary). To prevent unauthorized use, smart card 300 includes a Personal Identification Number (PIN) 306, which must match a PIN entered by the user into a user keypad 122 shown in FIG. 1. Also included in smart card 300 is an account record 308 specific for the user. This record contains a listing of authorized products as determined by WIC eligibility guidelines, and shows the current authorized allocation of products for that user. For example, if the user is authorized to receive four gallons of milk per month, all of which will be paid for by WIC, and the user has already received three WIC-paid gallons of milk in the current month, then WIC will pay for only one more gallon of milk during the current month.

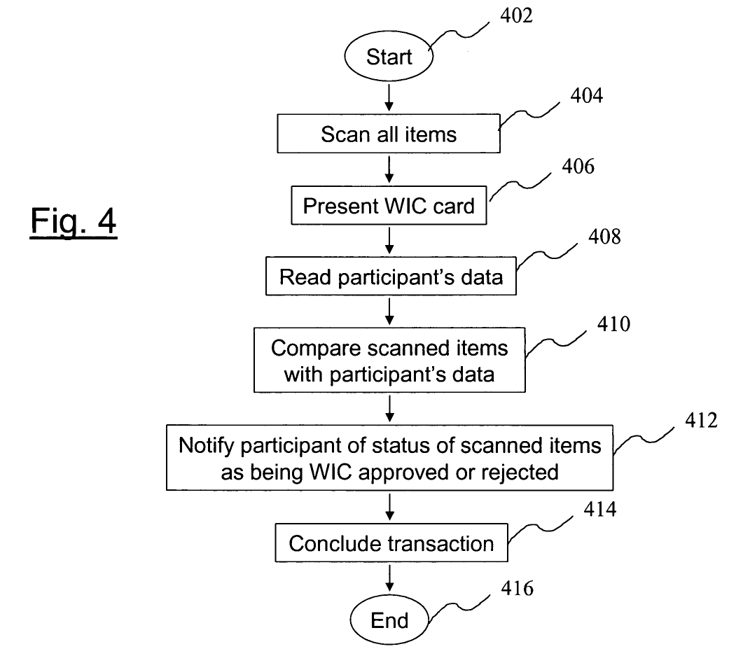

With reference now to FIG. 4, a flow-chart of exemplary steps taken in a preferred embodiment of the present invention is provided. After initiator block 402, a shopper places selected items for purchase on a conveyor belt at a check-out station in a grocery store. All of these items are scanned using a standard laser scanner to scan a bar code on the product (block 404).

After all items have been scanned, then the user presents her government assistance card, such as a WIC smart card (block 406), to tender payment for some or all of the scanned items. As described above, this WIC smart card includes not only an identifier number for the user, but also a password (PIN) and an account record for that user, which is read off the WIC smart card (block 408). To use the WIC smart card, the shopper must enter her matching PIN into a user keypad (shown as user keypad 122 in FIG. 1).

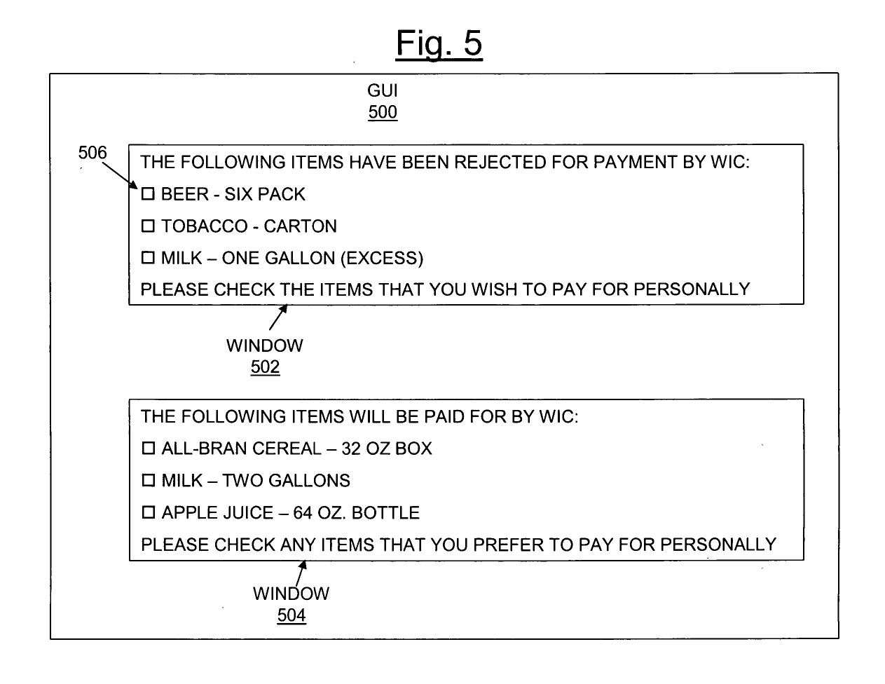

At step 410, the computer system (either computer system 102 or remote server 128 shown in FIG. 1) compares all items that have been scanned with the listing of authorized items shown in program data 146 and/or 246. The computer system 102 then provides the shopper (WIC beneficiary/participant) with a description of which items are eligible for WIC payment (block 412). This listing may be in the form of a tape printed by printer 120 (see FIG. 1), or preferably is displayed in display 110 (FIG. 1) as an interactive display. For example, refer now to FIG. 5, which shows an exemplary display Graphical User Interface (GUI) 500, which may be displayed on display 110 of FIG. 1. GUI 500 includes active windows 502 and 504. Window 502 shows items that have been rejected by WIC for payment, while window 504 shows items authorized for WIC payment. Each item has an active box 506 that can be clicked (such as by a stylus pen if display 110 is a touch-screen), allowing the user to personally pay for non-WIC items (window 502), or to not dun her WIC account (window 504) for WIC authorized items (e.g., if she wishes to save her benefits for later in the month). Thus, the user is provided a listing of which items will be paid for by WIC and those items' cash value, in order to allow the user to decide whether to use the WIC benefits for specific selected items, thus allowing her to manage her remaining WIC benefits balance.

Upon the user approving which items are and are not paid for WIC, the transaction is concluded (block 414). That is, items that are to be paid for by WIC are deducted from the total due from the WIC beneficiary, and these same items are reported to remote server 128 to be billed to the WIC program. Concurrently, the user pays for all selected non-WIC products, and the process ends (terminator block 416).

While the flow-chart of FIG. 4 is describe using a WIC smart card, alternatively a magnetic card can be used to identify an authorized user and to access that user's account information from a remote databank. For example, assume that in steps 406-410 that a magnetic card is swiped through the magnetic card reader 126 shown in FIG. 1. This magnetic card includes only minimal information about the user, including her name and possibly her PIN number. All other account information, including which items she is authorized to receive under the WIC program, may be maintained in program data 246, shown in FIG. 2 as associated with the remote server 128, which is accessible from the check-out station 100 via LAN 130 and/or WAN 134. Optionally, this data describing the user's account may be kept in the local program data 146 file in computer system 102 at the check-out station 100, in order to facilitate rapid local access of the data.

It should be understood that at least some aspects of the present invention may alternatively be implemented in a program product. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

The present invention therefore provides a useful means for paying for WIC or similar entitlement program benefits at the time of tender. Thus, there is no need to pre-sort the WIC authorized products before being scanned, nor is there a need to re-start the scanning process if the WIC beneficiary should fail to identify herself initially as a WIC participant. The transaction is seamless and appears to proceed like a non-entitlement transaction, thus avoiding any potential stigma that may be associated with using such a program.

While the invention has been particularly shown and described with reference to a preferred embodiment, it will be understood by those skilled in the art that various changes in form and detail may be made therein without departing from the spirit and scope of the invention. For example, while the present invention has been described for use with a government assistance program, it may also be utilized with any prescription based program, such as an “account based” or pre-paid account used by a student for the purchase of school supplies, snacks, etc.

What is claimed is:

1. A method comprising:
scanning a plurality of items at a check-out station in a store; and
upon completion of the scanning of all of the items at the check-out station, using a government assistance card to identify an eligible participant in a government assistance program, and subsequently receiving a tender for at least some of the items from the government assistance card, wherein the government assistance card provides access to a listing identifying which of the scanned items are qualified items that will be paid for by a government assistance program.

2. The method of claim 1, further comprising:
providing the listing of scanned qualified items to the eligible participant that is using the government assistance card, wherein the eligible participant is provided a option to forego purchasing an unauthorized item that is not on the listing of qualified items but has been scanned at the check-out station.

3. The method of claim 2, wherein the authorized user may choose to forego purchasing an authorized item that is on the listing of qualified items and has been scanned at the check-out station, such that the authorized item not purchased does not debit against an assistance account of the authorized user.

4. The method of claim 1, wherein the government assistance card is a smart card, and wherein the method further comprises:
receiving, upon the completion of the scanning of all of the items, the smart card in a smart card reader located at the check-out station, wherein the smart card contains information regarding which scanned items will be paid for by the government assistance program.

5. The method of claim 4, wherein a determination of which scanned items will be paid for by the government assistance program is based on a type and size of a product that was scanned, and whether the eligible participant using the government assistance card has exceeded an allotment for the product that was scanned.

6. The method of claim 1, wherein the government assistance card is a magnetic card that identifies the eligible participant in the government assistance program, the method further comprising:
upon the completion of the scanning of all the items, polling a remote database for the listing of which scanned items are qualified items that will be paid for by the government assistance program.

7. The method of claim 2, wherein the eligible participant is verified by an entry of a Personal Identification Number (PIN) onto a keypad located at the check-out station.

8. A system comprising:
a scanner for scanning a plurality of items at a check-out station in a store; and
a card reader for, upon completion of the scanning of all the items at the check-out station, reading a government assistance card to identify an eligible participant in a government assistance program, and subsequently receiving a tender for at least some of the items from the government assistance card, wherein the government assistance card provides access to a listing identifying which of the scanned items are qualified items that will be paid for by a government assistance program.

9. The system of claim 8, further comprising:
a display for providing the listing of scanned qualified items to the eligible participant that is using the government assistance card, wherein the eligible participant is provided an option to forego purchasing an unauthorized item that is not on the listing of qualified items but has been scanned at the check-out station.

10. The system of claim 8, further comprising:
a printer for providing the listing of scanned qualified items to the eligible participant that is using the government assistance card, wherein the eligible participant is provided an option to forego purchasing an unauthorized item that is not on the listing of qualified items but has been scanned at the check-out station.

11. The system of claim 8, wherein the government assistance card is a smart card, and wherein the system further comprises:
a smart card read for, upon the completion of the scanning of all the items, reading the smart card at the check-out station, wherein the smart card contains information regarding which scanned items will be paid for by the government assistance program.

12. The system of claim 11, wherein a determination of which scanned items will be paid for by the government assistance program is based on a type and size of a product that was scanned, and whether the eligible participant using the government assistance card has exceeded an allotment for the product that was scanned.

13. The system of claim 8, further comprising:
a magnetic card reader for reading a magnetic card, wherein the government assistance card is the magnetic card that identifies the eligible participant in the government assistance program; and
a network interface for, upon the completion of the scanning of all of the items, polling a remote database for the listing of which scanned items are qualified items that will be paid for by the government assistance program.

14. The system of claim 9, wherein the eligible participant is verified by an entry of a Personal Identification Number (PIN) onto a keypad located at the check-out station.

15. A computer program product, residing on a computer usable medium, comprising:
program code for scanning a plurality of items at a check-out station in a store; and
program code for, upon completion of the scanning of all of the items at the check-out station, using a government assistance card to identify an eligible participant in a government assistance program, and subsequently receiving a tender for at least some of the items from the government assistance card, wherein the government assistance card provides access to a listing identifying which of the scanned items are qualified items that will be paid for by a government assistance program.

16. The computer program product of claim 15, further comprising:
program code for providing the listing of scanned qualified items to the eligible participant that is using the government assistance card, wherein the eligible participant is provided a option to forego purchasing an unauthorized item that is not on the listing of qualified items but has been scanned at the check-out station.

17. The computer program product of claim 16, wherein the authorized user may choose to forego purchasing an authorized item that is on the listing of qualified items and has been scanned at the check-out station, such that the authorized item not purchased does not debit against an assistance account of the authorized user.

18. The computer program product of claim 15, wherein the government assistance card is a smart card, and wherein the computer program product further comprises:
program code for receiving, upon the completion of the scanning of all of the items, the smart card in a smart card reader located at the check-out station, wherein the smart card contains information regarding which scanned items will be paid for by the government assistance program.

19. The computer program product of claim 18, wherein a determination of which scanned items will be paid for by the government assistance program is based on a type and size of a product that was scanned, and whether the eligible participant using the government assistance card has exceeded an allotment for the product that was scanned.

20. The computer program product of claim 15, wherein the government assistance card is a magnetic card that identifies the eligible participant in the government assistance program, the computer program product further comprising:
program code for, upon the completion of the scanning of all of the items, polling a remote database for the listing of which scanned items are qualified items that will be paid for by the government assistance program.
